(19) United States
(12) Patent Application Publication
(10) Pub. No.: US 2021/0157632 A1
(43) Pub. Date: May 27, 2021

(54) CONTROLLING CALLS TO KERNELS

(71) Applicant: Hewlett-Packard Development Company, L.P., Spring, TX (US)

(72) Inventors: Raphael Gay, Fort Collins, CO (US); Kirsten Olsen, Fort Collins, CO (US); Tadeu Marchese, Porto Alegre (BR); Roberto Bender, Porto Alegre (BR)

(73) Assignee: Hewlett-Packard Development Company, L.P., Spring, TX (US)

(21) Appl. No.: 17/045,791

(22) PCT Filed: Jun. 22, 2018
(86) PCT No.: PCT/US2018/039068

§ 371 Date: Oct. 7, 2020

(51) Int. Cl. G06F 9/48; G06F 9/54; G06F 9/445

(52) U.S. Cl. CPC G06F 9/485; G06F 9/44521; G06F 9/4881; G06F 9/541

(57) ABSTRACT

Examples of methods for controlling calls to a kernel by a computing device are described herein. In some examples of the methods, an amount of calls from a program to a scheduler function in a kernel space are determined in a user mode. In an example, a call from the program is intercepted in the user mode and the call is filtered in response to determining that the amount of calls satisfies a filtering criterion.

### BACKGROUND

Computer technology has advanced to become virtually ubiquitous in society and has been used to improve many activities in society. For example, computers are used to perform a variety of tasks, including work activities, communication, research, and entertainment.

### BRIEF DESCRIPTION OF THE DRAWINGS

FIG. 1 is a block diagram of an example of a computing device that may be implemented to control calls to a kernel;

FIG. 2 is a flow diagram illustrating an example of a method for controlling calls to a kernel;

FIG. 3 is a block diagram illustrating an example of a user space and a kernel space;

FIG. 4 is a block diagram illustrating an example of a machine-readable storage medium; and

FIG. 5 is a thread diagram illustrating an example of controlling calls to a scheduler.

### DETAILED DESCRIPTION

A computing device is a type of electronic device that includes a processor and memory. The processor executes programs stored in the memory to perform a variety of operations. A program is a set of instructions or code that performs an operation when executed by the processor. Examples of programs include web browsers, word processors, calendar applications, video games, photo manipulation applications, document readers, email applications, presentation applications, video playback applications, audio playback applications, and others.

The memory may be divided into subsets referred to as kernel space and user space. Kernel space refers to resources for performing privileged or protected operations. For example, a kernel space may include a subset of memory (e.g., a set of memory addresses) where kernel processes are performed. The kernel space may be privileged in that kernel processes may directly access the kernel space, while other processes are restricted from directly accessing the kernel space. User space refers to resources for performing non-privileged or non-protected operations. For example, a user space may include a subset of memory (e.g., a set of memory addresses) where user processes (e.g., non-privileged programs, applications, drivers, etc.) are performed. The processor may operate in a kernel mode (e.g., ring 0) and a user mode (e.g., ring 3). The kernel mode is a state of a device (e.g., processor, processor core, computing device, system, etc.) when a kernel takes over execution. A kernel is a set of instructions or a program of an operating system. While in kernel mode, the processor may access kernel space and/or user space. For example, the kernel space may include resources that are available while in a kernel mode. Accordingly, kernel mode may be a state that includes protected resources, privileged resources, etc., specific to the kernel.

A user mode is a state of a device (e.g., processor, processor core, computing device, system, etc.) when non-privileged processing is performed. While in user mode, the processor may access user space, but may not directly access kernel space. In order for user processes or threads to access privileged functions, the user processes or threads may make a call (e.g., “system call”) that causes the processor to transition to kernel mode. For example, a program in a user space may make a call to a function that causes a transition (e.g., transitions execution) to the kernel mode (e.g., between the user mode and the kernel mode). A transition is a change in execution between the user mode and kernel mode. When a device (e.g., processor, processor core, computing device, system, etc.) transitions to kernel mode, the device may utilize the kernel resources (e.g., some operating system resources) and/or the kernel space. Transitioning between the user mode and kernel mode may be time consuming. Accordingly, making a large amount of calls to the kernel mode may impact performance.

As used herein, a “thread” is a set of instructions. A thread may be a unit or sequence of instructions that may be handled independently by a scheduler. A thread may be a subset of a process and/or program.

As used herein, a “call” is a function call or programmatic call. For example, a program may issue a call to a function. When a call is executed, the processor may access a portion of memory corresponding to the function indicated by a pointer in the memory.

As used herein, “ring” terminology refers to hierarchical domains referred to as protection rings. Ring 0 corresponds to kernel mode and is a most privileged ring, which allows access to kernel space (e.g., privileged system functions, privileged resources, hardware ports, etc.) and/or user space. Ring 3 corresponds to a user mode and is a least privileged ring, which allows access to the user space, but restricts direct access to the kernel space. As used herein, operations performed “in the user space” are performed while in user mode, and operations performed “in the kernel space” are performed while in kernel mode, unless otherwise indicated.

The processor may multi-task by performing different processes (e.g., threads) in periods of time referred to as time quanta (e.g., time slices). Some programs (e.g., software applications, libraries, and drivers) generate high rates of calls to OS libraries (e.g., application user interfaces (APIs) and/or dynamic link libraries (DLLs)) to release time quanta. Scheduling time quanta may be handled by a scheduler that operates in kernel mode (e.g., an operating system (OS) thread scheduler). The scheduler is a set of instructions or process that allocates time quanta to programs (e.g., processes or threads) for execution. The scheduler may include a scheduler function or scheduler functions. A scheduler function controls an aspect of scheduling (e.g., releasing time quanta). For example, a scheduler function is a function that schedules processing (e.g., allocates time slices for processing).

In some examples, a program may call a scheduler function to release time quanta. If the OS thread scheduler does not have another thread waiting to be resumed, the scheduler may immediately return to the program that made the call (the “caller”). If the program is still waiting on a condition, the program may immediately issue another time quanta release call. This behavior can be observed in several programs (e.g., applications, libraries, and drivers) on various operating systems (e.g., Windows, Linux, Mac OS, and others), which may result in very high rates of calls. For example, calls may sometimes occur on the order of millions per second. This may impact the performance of the computing device, the caller, and the other programs running on the computing device. It should also be noted that security patches released (for Spectre vulnerabilities, for example) may dramatically increase the latencies on each transition from user mode to kernel mode and back, which significantly impacts system performance (e.g., 30% or more in some cases). Some examples described herein allow reducing that performance loss by limiting the number of calls that are passed to the kernel. Accordingly, some examples of the techniques described herein may provide performance acceleration via filtering high rates of time quanta release calls from programs. Performance acceleration may be achieved by lowering the number of transitions in the OS from user mode to kernel mode. Accordingly, some of the techniques described herein may improve the functioning (e.g., operating efficiency) of a computing device.

In some examples, the techniques described herein may limit the rate of calls to the kernel scheduler services that manage thread quanta times. In some approaches, limiting the rate of calls may be achieved by inserting a DLL in front of kernel DLLs that provide services to release thread quanta (e.g., SwitchToThread (STT), Sleep(0), Sleep(1), SleepEx, SuspendThread, etc.). By limiting the rate of transitions from the user mode to the kernel mode and back, performance may be increased. For example, limiting the rate of transitions may enable less thrashing of branch predictors, translation lookaside buffers (TLBs), and/or caches, etc., particularly in the presence of security patches for vulnerabilities like Spectre.

Throughout the drawings, identical or similar reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

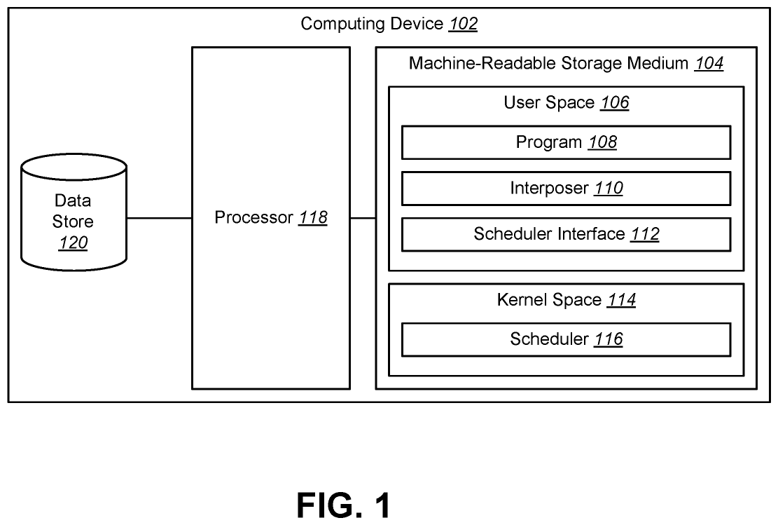

FIG. 1 is a block diagram of an example of a computing device 102 that may be implemented to control calls to a kernel (e.g., kernel functions). Examples of the computing device 102 include a personal computer, a server computer, a tablet computer, laptop computer, smartphone, gaming console, smart appliance, vehicle console device, etc. The computing device 102 may include a processor 118, a data store 120, and/or a machine-readable storage medium 104. The computing device 102 may include additional components (not shown) and/or some of the components described herein may be removed and/or modified without departing from the scope of this disclosure.

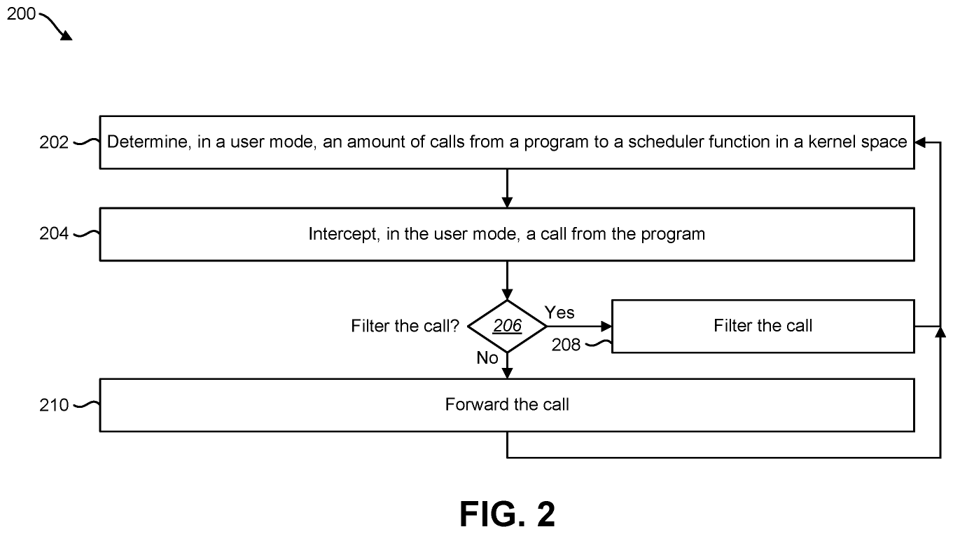

The processor 118 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the machine-readable storage medium 104. The processor 118 may fetch, decode, and/or execute instructions (e.g., program 108, interposer 110, scheduler interface 112, scheduler 116) stored on the machine-readable storage medium 104. It should be noted that the processor 118 may be configured to perform any of the functions, operations, steps, methods, etc., described in connection with FIGS. 2-5 in some examples.

The machine-readable storage medium 104 (e.g., memory) may be any electronic, magnetic, optical, or other physical storage device that contains or stores electronic information (e.g., instructions and/or data). Thus, the machine-readable storage medium 104 may be, for example, random access memory (RAM), electrically erasable programmable read-only memory (EEPROM), a storage device, flash memory, an optical disc, and the like. In some implementations, the machine-readable storage medium 104 may be a non-transitory machine-readable storage medium, where the term “non-transitory” does not encompass transitory propagating signals. The machine-readable storage medium 104 (e.g., memory) may be coupled to the processor 118. An instruction set stored on the machine-readable storage medium 104 (e.g., memory) may cooperate with the processor 118 (e.g., may be executable by the processor 118) to perform any of the functions, operations, methods, steps, and/or procedures described herein.

Examples of instructions and/or data that may be stored in the machine-readable medium 104 include libraries, DLLs, APIs, programs, drivers, applications, etc. A library is a set of executable code. For example, a library may include a set of functions that may be called for execution. A DLL is a type of library that may be accessed by creating a static or dynamic link. For example, a program 108 may link to and/or call functions of a DLL. An API is a set of instructions, routines, definitions, protocols, and/or data that enables access to certain functions or functionality. The instructions and/or data may be in the form of source code, compiled code, machine code, and/or binary code, etc.

The computing device 102 may also include a data store 120 on which the processor 118 may store information. The data store 120 may be volatile and/or non-volatile memory, such as dynamic random access memory (DRAM), EEPROM, magnetoresistive random-access memory (MRAM), phase change RAM (PCRAM), memristor, flash memory, and the like. In some examples, the machine-readable storage medium 104 may be included in the data store 120. Alternatively, the machine-readable storage medium 104 may be separate from the data store 120. In some approaches, the data store 120 may store similar instructions and/or data as that stored by the machine-readable storage medium 104. For example, the data store 120 may be non-volatile memory and the machine-readable storage medium 104 may be volatile memory.

In some implementations, the computing device 102 may communicate with various input and/or output devices, such as a keyboard, a mouse, a display, another apparatus, electronic device, computing device, etc., through which a user may input instructions into the computing device 102.

The machine-readable storage medium 104 may include a user space 106. It should be noted that the user space 106 may operate independently of any user in some cases and/or implementations. In some examples, the user space 106 may include a program 108, an interposer 110, and a scheduler interface 112.

The program 108 is a set of instructions or code that performs an operation when executed by the processor as described above. For example, the program 108 may be a web browser, email application, word processor, video game, etc. The program 108, a processor of the program 108, and/or a thread of the program 108 may issue calls to the scheduler interface 112 and/or to the scheduler 116. Examples of the calls may include SwitchToThread calls, Sleep(0) calls, Sleep(1) calls, SleepEx calls, SuspendThread, and/or other calls. In some examples, the functions called may be included in System Services, Processes and Threads, in Kernel32.dll in some architectures. It should be noted that other functions that may be called to release time quanta may be utilized (e.g., in 64-bit architectures).

The interposer 110 is a set of instructions or code that interposes between the program 108 and the scheduler interface 112 or between the program 108 and the scheduler 116. For example, the interposer 110 filters calls from the program 108 to the scheduler interface 112 and/or to the scheduler 116. Examples of the interposer 110 include DLLs, binary code, etc. For example, the interposer 110 may be an injected DLL or a DLL stored in the user space 106 via DLL injection. In DLL injection, a DLL may be stored in the user space 106 in place of other instructions or code. For example, the interposer 110 may be stored in the user space 106 such that calls that are directed to (e.g., pointed to) the scheduler interface 112, to the scheduler 116, or to a particular function are instead directed to (e.g., intercepted by) the interposer 110. For example, the current call may be directed to an interposer DLL that is different from an API corresponding to the current call. In another example, the interposer 110 may be binary code (e.g., modified binary) that intercepts calls directed to the scheduler interface 112 and/or the scheduler 116.

The scheduler interface 112 is a function that is called to access the scheduler 116. In some examples, the scheduler interface 112 includes multiple functions. Examples of the scheduler interface 112 include a SwitchToThread (STT) function, Sleep(0) function, Sleep(1) function, SleepEx function, an API that includes a function to access the scheduler 116, a DLL that includes a function to access the scheduler 116, etc. The SwitchToThread function may cause a thread that made the SwitchToThread call to yield execution to another thread that is ready for execution on the processor 118. The Sleep(0) function may suspend execution of a thread until after a time-out period, where the value 0 may cause the thread to release any remaining time slice to another thread with the same priority that is ready for execution. The Sleep(1) function may suspend execution of a thread until after a time-out period, where the value 1 may cause the thread to release any remaining time slice to another thread that is ready for execution, independent of the priority. The SleepEx function may suspend execution of a thread until a specified condition is met (e.g., a time-out period passes, a callback function is called, or an asynchronous procedure call (APC) is queued for the thread).

As described above, the kernel space 114 is a subset of the machine-readable storage medium 104 where kernel processes are performed. The kernel space 114 may include a function or functions (e.g., instructions for a kernel function or kernel functions). The scheduler 116 or scheduler functions are examples of functions in the kernel space 114. As described above, the scheduler 116 is a set of instructions or process that allocates time quanta to programs (e.g., processes or threads) for execution.

In some examples, the interposer 110 may determine, in the user mode, an amount of calls from the program 108 to the scheduler interface 112 and/or scheduler 116 in the kernel space 114. An amount of calls is a measure of the calls made from the program 108 to the scheduler interface 112 and/or the scheduler 116. The amount of calls may be determined on a program basis, on a thread basis, and/or a process basis. For example, the amount of calls may be based on the total calls from the program 108, based on the calls from each thread of the program 108, and/or based on each process associated with the program 108. In an example, the amount of calls may be a total amount of all calls from the program 108. In another example, the interposer 110 may determine an amount of calls for each individual thread of the program 108 that makes calls to the scheduler interface 112 and/or to the scheduler 116. In some examples, the interposer 110 may determine amounts of calls corresponding to multiple programs, multiple threads within multiple programs, and/or processes associated with multiple programs. Calls, threads, and/or processes that are not directed to the scheduler interface 112 and/or to the scheduler 116 may be disregarded.

In some examples, the amount of calls may relate to one function. For example, an amount of calls may be determined for a Sleep(0) function. In some examples, an amount of calls may be determined for multiple functions. For example, an amount of calls may be determined for a combination of SwitchToThread and Sleep(0) functions.

In some examples, the amount of calls may be an amount of time between a current call and a previous call from the program 108. In some approaches, the interposer 110 may determine a time for each call from the program 108 to the scheduler interface 112 and/or to the scheduler 116. The interposer 110 may calculate a difference between times corresponding to different calls. For example, the interposer 110 may subtract a time corresponding to a previous call from a time corresponding to a current call to determine the amount of time between the current call and the previous call. The previous call may be a call that occurred before the current call. For example, the previous call may be the last call from the program 108 before the current call, may be a last call from the program 108 that was forwarded to the scheduler interface 112 and/or scheduler 116, or may be another previous call. In some examples, the amount of calls may be an amount of time between a current call and a previous call from a thread of the program 108. For instance, the interposer 110 may determine amounts of calls as amounts of time between a previous call and a current call to the scheduler interface 112 and/or the scheduler 116 for each thread.

In some examples, determining the amount of calls may include counting a number of calls. For example, the interposer 110 may maintain a counter for calls made to the scheduler interface 112 and/or the scheduler 116. For instance, each time the program 108 issues a call to the scheduler interface 112 and/or the scheduler 116, the interposer 110 may increment the counter. The counter may be reset in some approaches. For example, the counter may be reset if an amount of time has elapsed without a call being issued or intercepted from the program 108 to the scheduler interface 112 and/or the scheduler 116. In another example, the counter for the program 108 may be reset if the program 108 is closed. In yet another example, the counter may be reset if the counter reaches a threshold count. In yet another example, the counter may be reset after a period of time.

In some examples, determining the amount of calls may include determining a frequency of calls or a rate of calls. For example, the interposer 110 may count a number of calls in a period of time. The interposer 110 may divide the number of calls (from a counter, for example) by the period of time to determine the frequency of calls or rate of calls. In some examples, the interposer 110 is a DLL in the user space 106 to determine the kernel scheduler call rate (e.g., a number of calls from the program 108 to the kernel scheduler 116 in a period of time). The frequency of calls or rate of calls may be determined for each program, for each process, and/or for each thread. The rate of calls may be referred to as a kernel scheduler call rate. In an example, a DLL including the interposer 110 may determine a kernel scheduler call rate as a number of calls from the program 108 to the kernel scheduler 116 in a period of time.

The interposer 110 may intercept a call from the program 108. As described above, intercepting a call that is directed to the scheduler interface 112 and/or to the scheduler 116 may be accomplished by placing the interposer 110 between the program and the scheduler interface 112 and/or between the program 108 and the scheduler 116. For example, DLL injection and/or modified binary code may be utilized to place the interposer 110 at a memory pointer associated with a call directed to the scheduler interface 112 and/or to the scheduler 116. For example, the scheduler interface 112 and/or the scheduler 116 may be displaced in memory by the interposer 110. Accordingly, when a call is directed to the scheduler interface 112 and/or to the scheduler 116, the processor 118 may instead execute instructions corresponding to the interposer 110.

The interposer 110 may filter, in the user mode, a call from the program 108. Filtering may include determining whether to block, delay, or forward a call. For example, the interposer 110 may delay or block the call in response to determining that the amount of calls satisfies a filtering criterion (e.g., blocking criterion and/or delaying criterion). Blocking may include discarding a call, disposing of a call, returning a call with a completion status or code, and/or not forwarding a call to the scheduler interface 112, to the scheduler 116, and/or to the kernel space 114. Delaying may include pausing a call for an amount of time (e.g., an amount of delay). For example, a call that is delayed may be delayed for a time and then forwarded. In some cases, a delayed call may ultimately be blocked. The amount of delay may be variable, may be fixed, may depend on determining the computing device's capabilities (e.g., how fast the computing device is, the type of processor or processors, etc.), may depend on the workload of the computing device 102 (e.g., all cores are busy, 50% of processing resources are being used, or another criterion), and/or may depend on the type of program, process and/or thread that is running, etc. A delay approach may be implemented instead of the blocking approach in some examples. Alternatively, a delay approach may be implemented in a complementary fashion to the blocking approach. For example, a delay approach may be implemented for certain programs, processes, and/or threads or all programs, processes and/or threads. Additionally or alternatively, a delay approach may be implemented in a coordinated (e.g., synchronized) fashion with the blocking approach (e.g., delay up to a threshold amount of time, block after that time, or block up to a threshold number of calls and delay after the number of calls, etc.).

A filtering criterion is a criterion for determining whether to delay and/or block a call or forward a call. In some examples, the filtering criterion is a threshold. In some approaches, the interposer 110 may select the filtering criterion, filtering criteria, filtering threshold, and/or filtering thresholds based on the calling program, process, and/or thread. For example, the filter policy can change based on the caller (e.g., specific application, process, driver, etc.). In some approaches, the interposer 110 may identify the caller by receiving an identifier from the caller and/or by tracing the memory pointer from which the call was issued. The interposer 110 may select the filtering criterion and/or threshold based on the program, process, and/or thread. For example, the interposer 110 may look up a filtering criterion and/or threshold based on a mapping (e.g., in a look up table, a list, an array, etc.) stored on the machine-readable storage medium 104 and apply the filtering criterion and/or threshold for the specific program, process, and/or thread.

In one example, the filtering criterion is a threshold time. For example, the filtering criterion may be satisfied if a time between a current call and a previous call is less than the threshold time. The threshold time may be a filtering period. A filtering period is an amount of time within which calls from a program, processor, or thread may be delayed and/or blocked. If the time between the current call and the previous call is greater than or equal to the threshold time (e.g., filtering period), the interposer 110 may forward the current call to the scheduler interface 112 and/or the kernel space 114 or scheduler 116. Forwarding a call may include passing the call to the scheduler interface 112 and/or to the scheduler 116. For example, the interposer 110 may call the scheduler interface 112 and/or the scheduler 116 for the forwarded call. Forwarding the call may allow the call to be executed by the scheduler interface 112 and/or the scheduler 116. For example, the current call may be forwarded to the kernel space via an API that includes the scheduler interface 112 and/or a function for calling the scheduler 116. In some examples, the interposer 110 may calculate a difference between a time of a current call of the program 108 to the kernel space 114 and a time of a last forwarded call of the program 108 to the kernel space 114. If the interposer 110 determines that the difference is greater than the filtering period, the interposer 110 may forward the current call to the kernel space 114 in response to the determination.

In another example, the filtering criterion may be a threshold number of calls. For example, if the counter indicates that the program 108 (or a process and/or thread of the program 108) has issued more than a threshold number of calls (within a period, for example), the interposer 110 may filter (e.g., delay and/or block) additional issued calls from the program 108 (for the remainder of the period, for example). If the number of calls is less than or equal to the threshold number of calls, the interposer 110 may forward the current call.

In another example, the filtering criterion may be a threshold frequency of calls or a threshold rate of calls. For example, if the counter indicates that the program 108 (or a process and/or thread of the program 108) has issued more than a threshold frequency of calls or threshold rate of calls (e.g., a kernel scheduler call rate) for a period, the interposer 110 may filter (e.g., delay and/or block) calls from the program 108 until the frequency of calls or rate of calls declines (to a frequency or rate less than or equal to the same or a different threshold). If the frequency of calls or rate of calls is less than or equal to the threshold frequency of calls or rate of calls, the interposer 110 may forward the current call.

It should be noted that other metrics and/or blocking criteria may be utilized. For example, average call rates, average number of calls over a set of periods, call rate trends, etc., may be utilized to filter calls from programs, processes, and/or threads. In some examples, the filtering criterion or criteria may be adjusted statically or dynamically based on the type of computing device 102, the computing device 102 configuration (how fast the computing device 102 is, the number of cores in the processor 118, etc.), the amount of resources used in the computing device 102 (e.g., how busy the cores are, etc.), and/or the application name or thread type, etc.

In some examples, the computing device 102 may activate or deactivate an aspect or aspects (e.g., functions, steps, etc.) of the techniques described herein. For example, the computing device 102 may activate or deactivate an aspect based on a command received via a command line. In some examples, the computing device 102 may display information related to an aspect or aspect of the techniques described herein. For example, the computing device 102 may display a call count, call rate, calling program, calling process, and/or calling thread. In some examples, the computing device 102 may change an amount of delay. For example, the computing device 102 may receive a value via a user interface that indicates a change to the amount of delay and may change the amount of delay based on the value.

FIG. 2 is a flow diagram illustrating an example of a method 200 for controlling calls to a kernel. The method 200 may be performed by, for example, the computing device 102 described in connection with FIG. 1. The computing device 102 may determine 202, in a user mode, an amount of calls from a program 108 to a scheduler 116 in a kernel space 114. For example, the interposer 110 may determine a time between a current call and a previous call, may count a number of calls, and/or may determine a frequency of calls or a rate of calls from the program 108, a process, and/or a thread, as described in connection with FIG. 1. In some examples, the amount of calls may be determined for multiple programs, processes, and/or threads.

The computing device 102 may intercept 204, in the user mode, a call from the program 108. For example, the interposer 110 may be executed as a result of a call from the program 108 as described in connection with FIG. 1. While the call may be issued to the scheduling interface 112 and/or scheduler 116, the processor 118 may execute interposer 110 instructions instead. It should be noted that the amount of calls may or may not be determined based on the call (e.g., the current call) or a time associated with the current call.

The computing device 102 may determine 206 whether to filter the call. For example, the interposer 110 may determine whether the amount of calls satisfies a filtering criterion as described in connection with FIG. 1. For instance, if an amount of time between the call and a previous call is less than a threshold time, the filtering criterion may be satisfied. The computing device 102 may filter 208 (e.g., delay or block) the call in response to determining that the amount of calls satisfies the filtering criterion. For example, the computing device 102 may determine, in the user mode, that a kernel scheduler call rate of a program 108 is greater than a rate threshold and filter (e.g., delay or block), in the user mode, the call from the program. Alternatively, the computing device 102 may forward 210 the call in response to determining that the amount of calls does not satisfy the filtering criterion. As illustrated in FIG. 2, the method 200, a step, and/or multiple steps of the method 200 may be repeated. For example, the method 200 may be performed for multiple programs, multiple processes, and/or multiple threads.

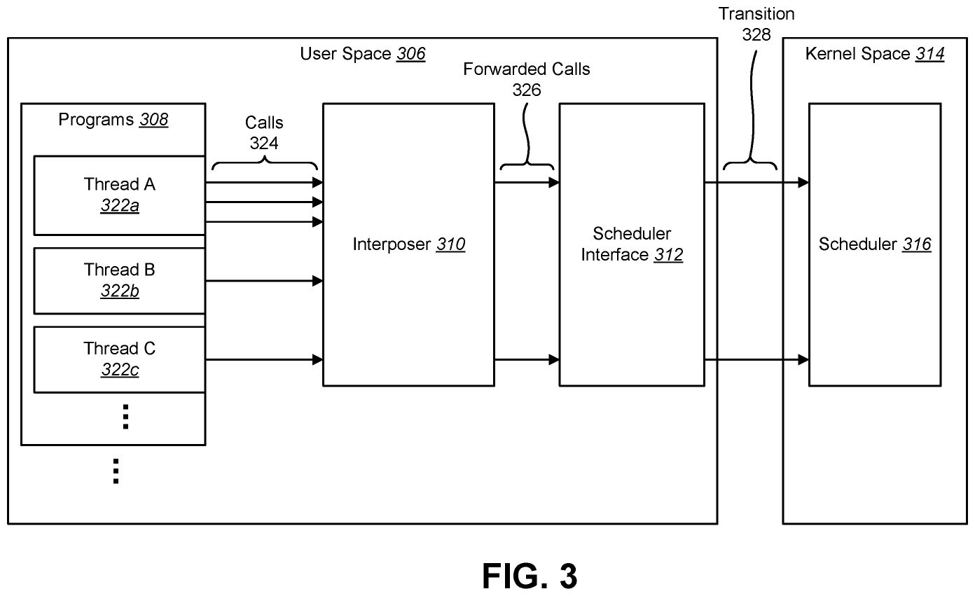

FIG. 3 is a block diagram illustrating an example of a user space 306 and a kernel space 314. The user space 306 may be an example of the user space 106 described in connection with FIG. 1 and the kernel space 314 may be an example of the kernel space 114 described in connection with FIG. 1. The user space 306 may correspond to a user mode and/or ring 3. The kernel space 314 may correspond to a kernel mode and/or ring 0.

As described above, one current problem is that some applications, drivers, and benchmarks generate millions of calls per second. These calls may be used to rendezvous (RDV) threads, increase performance, or keep cores up and running. After some security patches, higher entry and/or exit latencies have occurred, where some structures (e.g., TLBs, branch predictors (BPs), prefetch buffers (PBs), etc.) may get flushed, thereby slowing down the applications. The impact on performance can be drastic (e.g., up to 50% reduction in performance). In some examples, some of the techniques described herein may help to reduce the performance loss incurred by some security patches. For example, some security patches may incur increased penalties for ring 3-to ring 0-to ring 3 transitions. It should be noted that performance can suffer in devices that do not have the security patches. Accordingly, some of the techniques described herein may be beneficial for devices that do not have the security patches as well as for devices that have implemented some security patches (to address the Spectre vulnerability, for example).

In the example illustrated in FIG. 3, the user space 306 includes multiple programs 308 (e.g., applications), an interposer 310, and a scheduler interface 312. The programs 308, interposer 310, and/or scheduler interface 312 may be examples of corresponding elements described in connection with FIG. 1. The kernel space 314 may include a scheduler 316, which may be an example of the scheduler 116 described in connection with FIG. 1.

Each of the programs 308 includes a thread. As illustrated in FIG. 3, one program 308 includes thread A 322a, thread B 322b, and thread C 322c. In this example, each of the threads 322a-c issues calls 324. The calls 324 may be directed to a scheduler interface 312 and/or to the scheduler 316.

The interposer 310 intercepts the calls 324. For example, the interposer 310 may be implemented by DLL injection in front of a SwitchToThread API and/or a Sleep( ) API, with the same names.

The interposer 310 may filter the calls 324. For example, the interposer 310 may reduce the number of calls 324 to a number of forwarded calls 326. Reducing the number of calls may be accomplished as described in connection with FIG. 1 and/or FIG. 2. For example, the interposer 310 may delay and/or block some of the calls 324 that satisfy a filtering criterion. The interposer 310 may provide forwarded calls 326 for other calls 324 that do not satisfy the filtering criterion (or that satisfy a forwarding criterion). The interposer 310 may issue the forwarded calls 326 to the scheduler interface 312.

The scheduler interface 312 may provide an interface to the scheduler 316 in the kernel space 314. For example, the scheduler interface 312 may include a SwitchToThread function and/or a Sleep(0) function. In some examples, the SwitchToThread function and the Sleep(0) function are included in a DLL (e.g., Ntdll.dll). For the forwarded calls 326, the scheduler interface 312 passes execution to the scheduler 316 with corresponding transitions 328.

As illustrated in FIG. 3, excessive or “pathological” burst calls are throttled to a low rate, which may lead to a significant reduction in Ring 0 transition penalties. Legitimate calls, or low rate calls, may be forwarded. Some examples of this approach may be beneficial by reducing transition penalties with little or no impact on programs (e.g., applications, drivers, etc.) or on compatibility.

It should be noted that although a single arrow is utilized to illustrate each call 324, each forwarded call 326, and each transition 328, the scheduler 316 may transition back to the user mode, and execution for a call 324 and/or forwarded call 326 may be passed back to a thread in response to the call 324 and/or forwarded call 326. For example, the Sleep( ) function may not have a return value, but a return from procedure (RET) instruction may be performed by the processor to return the program counter to the caller. In another example, a return value may be provided from the interposer 310, the scheduler interface 312, and/or the scheduler 316. For example, SleepEx may return zero or a WAIT_IO_COMPLETION value (e.g., a value corresponding to 192 in decimal). When blocking a call (to SleepEx, for example), the interposer 310 may return zero. The return value zero may indicate that a specified time interval expired. When forwarding a call, the interposer 310 may return a value to the calling program 308, process, and/or thread (e.g., a value returned by the scheduler interface 312 in response to a forwarded call 326). In some examples, every call may be returned to be considered completed. For example, the interposer 310 may return a value indicating a completion status or code (even if a call may be delayed or blocked, for instance).

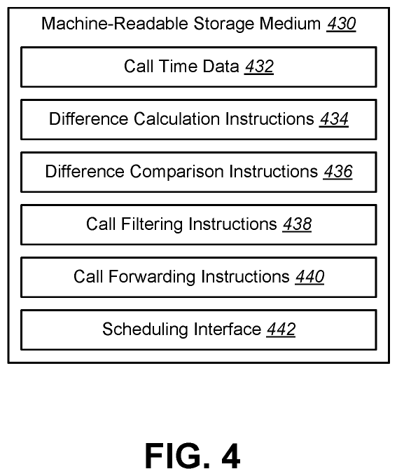

FIG. 4 is a block diagram illustrating an example of a machine-readable storage medium 430. Examples of the machine-readable storage medium 430 may include RAM, EEPROM, a storage device, an optical disc, and the like. In some implementations, the machine-readable storage medium 430 may be housed in a computing device or externally from a computing device (e.g., computing device 102). For example, the machine-readable storage medium 430 may be a solid-state drive (SSD) housed in a computing device or may be external flash memory that may be coupled to a computing device. In some implementations, the machine-readable storage medium 430 may be an example of the machine-readable storage medium 104 described in connection with FIG. 1. In some examples, the machine-readable storage medium 430 described in connection with FIG. 4 may be utilized instead of (e.g., in place of) the machine-readable storage medium 104 described in connection with FIG. 1. The machine-readable storage medium 430 may include code (e.g., instructions) that may be executed by processor(s) (e.g., a computing device).

The machine-readable storage medium 430 may include call time data 432. A processor may store the call time data 432 in the machine-readable storage medium when a call is issued from a program (e.g., process or thread) to a scheduling interface 442. For example, a processor may time stamp calls from the program using times indicated by an operating system clock.

The machine-readable storage medium 430 may include difference calculation instructions 434. When executed, the difference calculation instructions 434 may cause a computing device to calculate a difference between call times corresponding to different calls. For example, the difference calculation instructions 434 may cause a computing device (e.g., computing device 102) to subtract a previous call time from a current call time to determine a difference between a time of a current call to a kernel space and a time of a last forwarded call to the kernel space from a program.

The machine-readable storage medium 430 may include difference comparison instructions 436. When executed, the difference comparison instructions 436 may cause a computing device (e.g., computing device 102) to compare the difference with a filtering period. For example, the difference comparison instructions 436 may cause a computing device (e.g., computing device 102) to compare the difference with a time threshold that represents the filtering period. If the difference is less than the filtering period (e.g., time threshold), the computing device (e.g., computing device 102) may execute call filtering instructions 438.

When executed, the call filtering instructions 438 may cause the computing device to delay or block the call. For example, the computing device may delay the call (and forward the call after the delay), or may discard the call and/or may not forward the call.

If the difference is greater than or equal to the filtering period (e.g., time threshold), the computing device (e.g., computing device 102) may execute the call forwarding instructions 440. When executed, the call forwarding instructions 440 may cause the computing device to forward the call to the scheduling interface 442.

In some examples, controlling calls to a kernel (e.g., a kernel function or kernel functions) may be performed in accordance with the following approach. For instance, the difference calculation instructions 434, difference comparison instructions 436, call filtering instructions 438, and/or call forwarding instructions 440 may be implemented in accordance with the following approach. Additionally or alternatively, some examples of the interposer 110 may be implemented in accordance with the following approach. In this approach, a current time may be determined based on a read time stamp counter (RDTSC), which is a function that returns a time stamp counter. If a difference between the current time and a time of a last forwarded call to the kernel scheduler (for a given thread ID (TID), for example) is greater than a filtering period or a time threshold, then the time of a last forwarded call may be updated to the current time and the call may be forwarded. Otherwise, a pause or delay may be executed. It should be noted that this approach may vary per program, process, and/or thread in some examples. The time stamp counter may be one example of a measure of time and/or may indicate a number of cycles since reset. In some examples, if the called API is Sleep( ), then the computing device may filter in accordance with the approach if a sleep function (e.g., Sleep(0), Sleep(1), SleepEx(0), SleepEx(1), SleepEx(true), or SleepEx(false)) is called. If not, the computing device may forward the call.

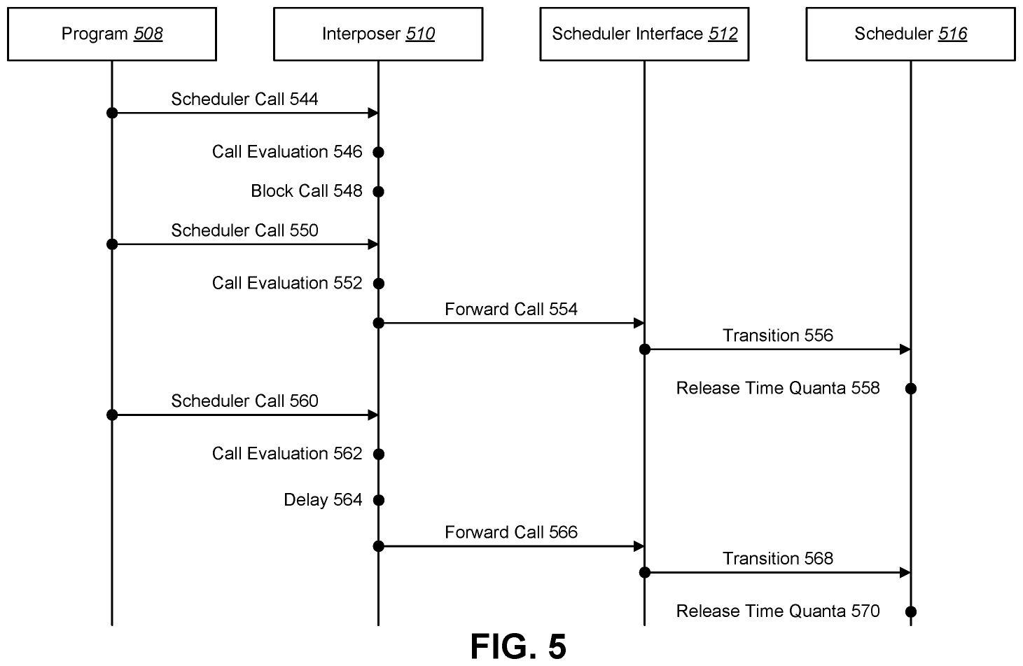

FIG. 5 is a thread diagram illustrating an example of controlling calls to a scheduler 516. In particular, FIG. 5 illustrates a program 508, an interposer 510, a scheduler interface 512, and a scheduler 516. The program 508 may be an example of the program 108 described in connection with FIG. 1. The interposer 510 may be an example of the interposer 110 described in connection with FIG. 1. The scheduler interface 512 may be an example of the scheduler interface 112 described in connection with FIG. 1. The scheduler 516 may be an example of the scheduler 116 described in connection with FIG. 1.

In this example, the program 508 issues a scheduler call 544 to the interposer 510. The interposer 510 performs call evaluation 546. For example, the interposer 510 determines whether to block or forward the call as described herein. In this case, the interposer 510 determines that the call meets the filtering criterion and blocks the call 548.

In this example, the program 508 later issues another scheduler call 550 to the interposer 510. The interposer 510 performs another call evaluation 552. In this case, the interposer 510 determines that the call does not meet the filtering criterion and forwards the call 554 to the scheduler interface 512 (e.g., API).

The scheduler interface 512 responds to the forwarded call 554 by performing a transition 556 to the scheduler 516. For example, the scheduler interface 512 passes execution to the scheduler 516 in a kernel mode. The scheduler 516 may release time quanta 558.

In this example, the program 508 later issues another scheduler call 560 to the interposer 510. The interposer 510 performs another call evaluation 562. In this case, the interposer 510 determines that the call meets a filtering criterion (e.g., the same filtering criterion for blocking or a different filtering criterion for delaying) and delays 564 the call. The interposer 510 forwards the call 566 to the scheduler interface 512 (e.g., API) after the delay 564.

The scheduler interface 512 responds to the forwarded call 566 by performing a transition 568 to the scheduler 516. For example, the scheduler interface 512 passes execution to the scheduler 516 in a kernel mode. The scheduler 516 may release time quanta 570.

While some specific examples have been provided herein, it should be noted that the principles disclosed herein may be applied in a variety of contexts. For example, some approaches described herein may be applied to any library, of any OS, used by threads to yield their quanta (e.g., Sleep, SleepEx, SwitchToThread, etc.). Some approaches interpose code on any such calls to take actions such as: letting a call proceed if a Sleep( ) parameter is different from 0 or 1, inserting a delay (e.g., 20 microseconds (μs)) by using PAUSE instructions and then letting the call proceed after the delay. Delay values may vary according to the processor frequency (e.g., 3 μs, 6 μs, 20 μs, 50 μs, etc.). In some approaches, the delay value may be calculated based on profiling tests. In some examples, the interposer 510 may not provide a return value. For example, Sleep( ) and SwitchToThread( ) do not have a return value. Accordingly, the interposer 510 may not provide a return value if the called function is Sleep( ) or SwitchToThread( ). In some examples, the interposer 510 may provide a return value. For example, SleepEx( ) may return 0 or WAIT_IO_COMPLETION (e.g., 192 in decimal). Accordingly, the interposer 510 may return 0 or WAIT_IO_COMPLETION in a case that the called function is SleepEx( ).

Filtering may be applied to (but not limited to) all processes, a subset of processes, and/or a subset of threads within a process. The delay or returning actions may be (but are not limited to being) fixed, may be based on history, timing, patterns of the previous calls, may be proportional to the number of calls per second, may be no action, and/or may be enabled based on reaching a threshold in the number of calls per second. While Sleep(0) and Sleep(1) have been given as examples, some approaches may be applied to the excessive use of Sleep(above 1) cases.

1. A method for controlling calls to a kernel by a computing device, comprising:
determining, in a user mode, an amount of calls from a program to a scheduler function in a kernel space;
intercepting, in the user mode, a call from the program; and
filtering the call in response to determining that the amount of calls satisfies a filtering criterion.

2. The method of claim 1, wherein the amount of calls is a time between the call and a previous call from the program.

3. The method of claim 2, wherein the time is less than a threshold time to satisfy the filtering criterion, and wherein the method further comprises forwarding a second call in response to determining that a second time between the second call and the previous call is greater than the threshold time.

4. The method of claim 1, wherein filtering the call comprises delaying or blocking the call.

5. The method of claim 1, wherein determining the amount of calls comprises counting a number of calls or determining a frequency of calls.

6. The method of claim 1, wherein the call is a SwitchToThread (STT) call, a Sleep(0) call, a Sleep(1) call, or a SleepEx call.

7. A computing device, comprising:
a processor;
a memory coupled to the processor, wherein the memory comprises a kernel space and a user space;
an instruction set to cooperate with the processor and the memory to:
determine, in a user mode, that a kernel scheduler call rate of a program is greater than a threshold; and
filter, in the user mode, a call from the program in response to the determination.

8. The computing device of claim 7, wherein the call is to cause a transition between the user mode and a kernel mode.

9. The computing device of claim 7, wherein the instruction set comprises a dynamic link library (DLL) in the user space to determine the kernel scheduler call rate.

10. The computing device of claim 9, wherein the DLL is to determine the kernel scheduler call rate as a number of calls from the program to a kernel scheduler in a period of time.

11. The computing device of claim 7, wherein the instruction set is to select the threshold based on the program.

12. A non-transitory machine-readable storage medium encoded with instructions executable by a processor, the machine-readable storage medium comprising instructions to:
calculate a difference between a time of a current call to a kernel space and a time of a last forwarded call to the kernel space of a program;
determine that the difference is greater than a filtering period; and
forward the current call to a function in the kernel space in response to the determination.

13. The storage medium of claim 12, further comprising instructions to block or delay a call to the function in the kernel space during the filtering period.

14. The storage medium of claim 12, further comprising instructions to direct the current call to an interposer dynamic link library (DLL) that is different from an application programming interface (API) corresponding to the current call.

15. The storage medium of claim 14, further comprising instructions to forward the current call to the function in the kernel space via the API.
